(19) United States
(12) Patent Application Publication
(10) Pub. No.: US 2026/0178205 A1
(43) Pub. Date: Jun. 25, 2026

(54) POWER REDUCTION FOR COMMAND SUB-QUEUE MEMORIES

(71) Applicant: Advanced Micro Devices, Inc., Santa Clara, CA (US)

(72) Inventor: Carlos Andres Cabrera, Lakeway, TX (US)

(73) Assignee: Advanced Micro Devices, Inc., Santa Clara, CA (US)

(21) Appl. No.: 18/987,992

(22) Filed: Dec. 19, 2024

(51) Int. Cl. G06F 3/06

(52) U.S. Cl. CPC G06F 3/0625; G06F 3/0634; G06F 3/0659; G06F 3/0673

(57) ABSTRACT

A memory controller for a memory channel includes first and second command sub-queues having corresponding first and second arbiters for selecting requests from respective ones of first and second queues for issuance as commands to the memory channel, and a power control circuit operable to place one of the first command sub-queue and the second command sub-queue into a low power mode while keeping another one of the first command sub-queue and the second command sub-queue active.

### BACKGROUND

Dynamic random-access memory (DRAM) chips include large arrays of memory cells formed by tiny storage capacitors in which the amount of stored charge corresponds to the logic state of the memory cell. Most DRAM chips sold today are compatible with various double data rate (DDR) DRAM standards promulgated by the Joint Electron Devices Engineering Council (JEDEC). DDR DRAMs are not completely random access, because instead of being accessed directly, the contents of a DDR DRAM's memory cells are first read from the memory array into a static buffer known as a page buffer in an operation known as an activate operation. After the activate operation, the contents of the page can be accessed at high-speed directly from the page buffer. Before the memory controller can read the contents of another page, it performs a “precharge” operation, in which the potentially modified contents of the page buffer are rewritten to the memory array. To reduce the overhead of constantly activating and then precharging different rows in the memory, memory controllers for DDR DRAMs maintain a large pool of memory operations waiting to be scheduled in a circuit known as a “command queue”, from which the memory controller can pick requests to access the current or “open” page if available. The command queue and the logic that schedules the memory access cycles cause the DDR DRAM memory controller to be a relatively large, high power consumption circuit. It would be desirable to reduce the power consumption of data processors and SOCs with DDR DRAM memory controllers without significantly growing circuit area.

### BRIEF DESCRIPTION OF THE DRAWINGS

FIG. 1 illustrates in block diagram form a data processing system according to some implementations;

FIG. 2 illustrates in block diagram form an accelerated processing unit (APU) suitable for use in the data processing system of FIG. 1;

FIG. 3 illustrates in block diagram form a memory controller and associated physical interface (PHY) suitable for use in the APU of FIG. 2 according to some implementations;

FIG. 4 illustrates in block diagram form another memory controller and associated PHY suitable for use in the APU of FIG. 2 according to some implementations;

FIG. 5 illustrates in block diagram form a memory controller according to some implementations;

FIG. 6 illustrates in block diagram form a portion of a memory controller with a sub-queue architecture;

FIG. 7 illustrates in block diagram form a portion of a memory controller with a sub-queue architecture according to some implementations;

FIG. 8 illustrates in block diagram form a portion of another memory controller with a sub-queue architecture according to some implementations;

FIG. 9 illustrates in block diagram form a portion of yet another memory controller with a sub-queue architecture according to some implementations;

FIG. 10 illustrates in block diagram form a portion of yet another memory controller with a sub-queue architecture according to some implementations; and

FIG. 11 illustrates a flow chart of a method of saving power in a multi-queue architecture according to some implementations.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate implementations using suitable forms of indirect electrical connection as well. The following Detailed Description is directed to electronic circuitry, and the description of a block shown in a drawing figure implies the implementation of the described function using suitable electronic circuitry, unless otherwise noted.

### DETAILED DESCRIPTION OF ILLUSTRATIVE IMPLEMENTATIONS

It would be desirable to reduce the power consumption of a memory controller that forms a substantial portion of data processing chips and systems-on-chip (SOCs) that are popular in low-power and mobile applications, while maintaining high bus efficiency. A certain memory controller architecture known as the command sub-queue architecture, which was developed to allow faster command processing, also allows significant power reduction under various workloads.

In particular, using an architecture known as the command sub-queue architecture, a large command queue can be broken into sub-queues having about the same total size as known memory controllers, while providing significant power reduction. The power reduction results from the observation that under typical, non-peak workloads, memory access requests are picked from among only some entries of the command queue, while other entries wait to be picked. One example is memory cycle type, either read cycles or write cycles. Since DDR DRAM buses but can only be driven in one direction at a time, the memory controller issues either read commands or write commands before switching to the opposite commands type. However, the amount of time required for DDR DRAMs to switch from read mode to write mode is significant, and has increased as DRAM clock speeds have increased.

The sub-queue architecture can be exploited by putting certain command sub-queues into a low power mode while one type of command (e.g., read or write) is being executed, while keeping the other type of command (e.g., write or read) active. One especially useful low-power mode is known as clock gating. During clock gating, the transistors do not switch but memory and logic states are preserved. Clock gating eliminates dynamic power loss, which is the largest component of power consumption. In this example, when the system is depleted of current mode commands, it can switch modes and enable cross mode commands. Clock gating is especially useful not only because of its low power consumption but also because of its low exit latency. Powerdown mode is a low power mode in which the power supply is removed from the powered down circuits. While it eliminates both dynamic power consumption and static leakage power consumption, it has longer exit latency. Depending on the size of the commands sub-queues, various other low-power commands may be used.

A memory controller for a memory channel includes first and second command sub-queues having corresponding first and second arbiters for selecting requests from respective ones of first and second queues for issuance as commands to the memory channel, and a power control circuit operable to place one of the first command sub-queue and the second command sub-queue into a low power mode while keeping another one of the first command sub-queue and the second command sub-queue active.

A data processing system includes a data processor core for generating memory access requests, a memory controller coupled to the data processor core to generate memory commands responsive to the memory access requests, and a memory coupled to the memory controller over a memory channel and responsive to the memory access requests to transfer data to or from the memory controller. The memory controller includes first and second command sub-queues having corresponding first and second arbiters for selecting requests from respective ones of first and second queues for issuance as commands to the memory channel, and a power control circuit operable to place one of the first command sub-queue and the second command sub-queue into a low power mode while keeping another one of the first command sub-queue and the second command sub-queue active.

A method includes selecting a first mode of operation corresponding to memory access requests of a first type. A second command sub-queue is put into a low-power mode. Memory access requests of the first type are stored in a first command sub-queue. Memory commands corresponding to selected memory access requests are sent to a memory system in response to arbitrating among the memory access requests of the first type in the first command sub-queue.

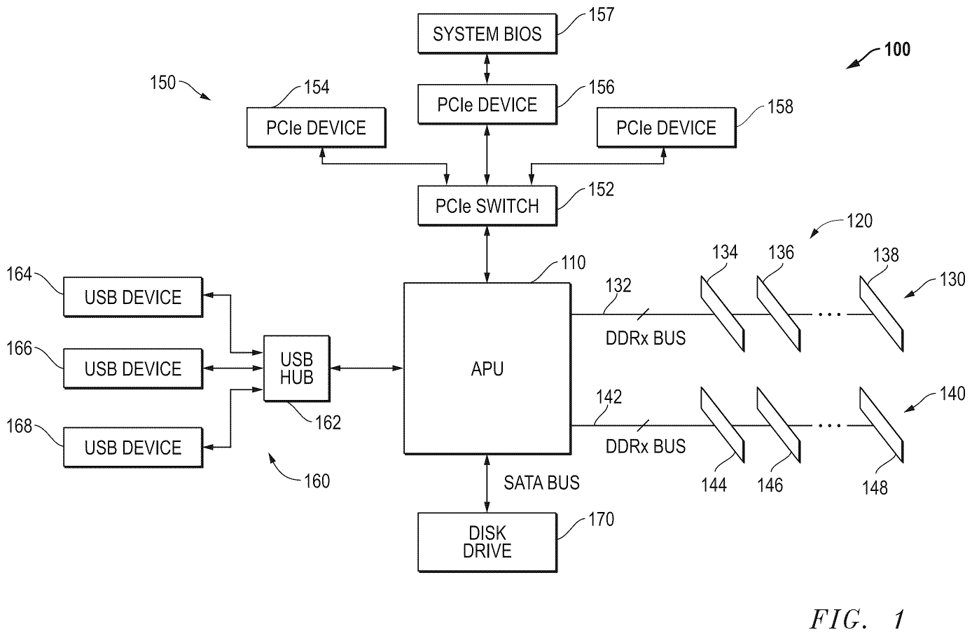

FIG. 1 illustrates in block diagram form a data processing system 100 according to some embodiments. Data processing system 100 includes generally a data processor 110 in the form of an accelerated processing unit (APU), a memory system 120, a peripheral component interconnect express (PCIe) system 150, a universal serial bus (USB) system 160, and a disk drive 170. Data processor 110 operates as the central processing unit (CPU) of data processing system 100 and provides various buses and interfaces useful in modern computer systems. These interfaces include two double data rate (DDRx) memory channels, a PCIe root complex for connection to a PCIe link, a USB controller for connection to a USB network, and an interface to a Serial Advanced Technology Attachment (SATA) mass storage device.

Memory system 120 includes a memory channel 130 and a memory channel 140. Memory channel 130 includes a set of dual inline memory modules (DIMMs) connected to a DDRx bus 132, including representative DIMMs 134, 136, and 138 that in this example correspond to separate ranks. Likewise, memory channel 140 includes a set of DIMMs connected to a DDRx bus 142, including representative DIMMs 144, 146, and 148.

PCIe system 150 includes a PCIe switch 152 connected to the PCIe root complex in data processor 110, a PCIe device 154, a PCIe device 156, and a PCIe device 158. PCIe device 156 in turn is connected to a system basic input/output system (BIOS) memory 157. System BIOS memory 157 can be any of a variety of non-volatile memory types, such as read-only memory (ROM), flash electrically erasable programmable ROM (EEPROM), and the like.

USB system 160 includes a USB hub 162 connected to a USB master in data processor 110, and representative USB devices 164, 166, and 168 each connected to USB hub 162. USB devices 164, 166, and 168 could be devices such as a keyboard, a mouse, a flash EEPROM port, and the like.

Disk drive 170 is connected to data processor 110 over a SATA bus and provides mass storage for the operating system, application programs, application files, and the like.

Data processing system 100 is suitable for use in modern computing applications by providing a memory channel 130 and a memory channel 140. Each of memory channels 130 and 140 can connect to state-of-the-art DDR memories such as DDR version four (DDR4), low power DDR4 (LPDDR4), graphics DDR version five (gDDR5), and high bandwidth memory (HBM), and can be adapted for future memory technologies. These memories provide high bus bandwidth and high speed operation. At the same time, they also provide low power modes to save power for battery-powered applications such as laptop computers, and also provide built-in thermal monitoring.

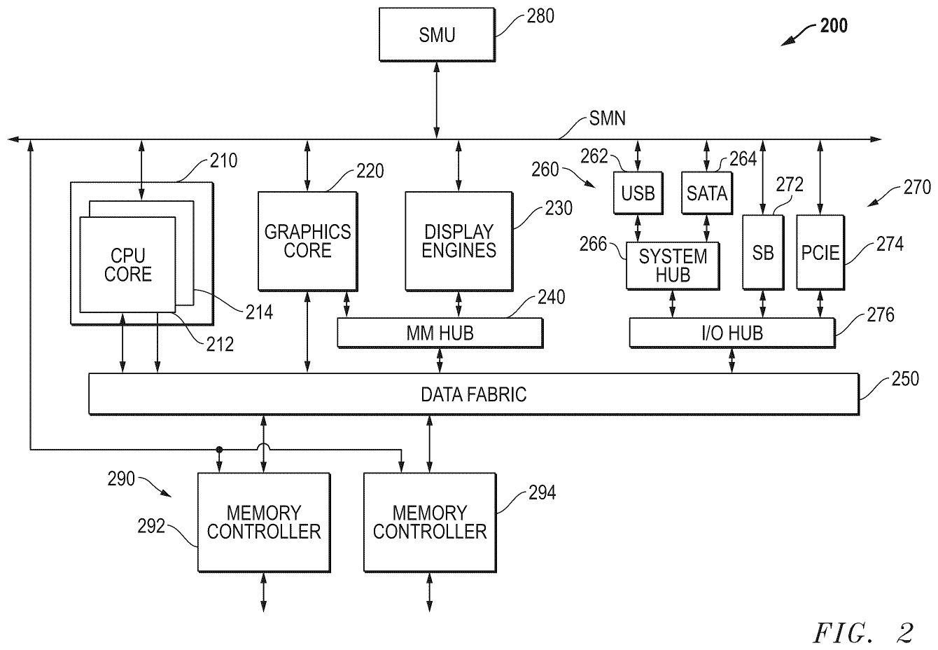

FIG. 2 illustrates in block diagram form an APU 200 suitable for use in data processing system 100 of FIG. 1. APU 200 includes generally a central processing unit (CPU) core complex 210, a graphics core 220, a set of display engines 230, a memory management hub 240, a data fabric 250, a set of peripheral controllers 260, a set of peripheral bus controllers 270, a system management unit (SMU) 280, and a set of memory controllers 290. CPU core complex 210 includes a CPU core 212 and a CPU core 214. In this example, CPU core complex 210 includes two CPU cores, but in other embodiments CPU core complex can include an arbitrary number of CPU cores. Each of CPU cores 212 and 214 is bidirectionally connected to a system management network (SMN), which forms a control fabric, and to data fabric 250, and is capable of providing memory access requests to data fabric 250. Each of CPU cores 212 and 214 may be unitary cores, or may further be a core complex with two or more unitary cores sharing certain resources such as caches.

Graphics core 220 is a high performance graphics processing unit (GPU) capable of performing graphics operations such as vertex processing, fragment processing, shading, texture blending, and the like in a highly integrated and parallel fashion. Graphics core 220 is bidirectionally connected to the SMN and to data fabric 250, and is capable of providing memory access requests to data fabric 250. In this regard, APU 200 may either support a unified memory architecture in which CPU core complex 210 and graphics core 220 share the same memory space, or a memory architecture in which CPU core complex 210 and graphics core 220 share a portion of the memory space, while graphics core 220 also uses a private graphics memory not accessible by CPU core complex 210.

Display engines 230 render and rasterize objects generated by graphics core 220 for display on a monitor. Graphics core 220 and display engines 230 are bidirectionally connected to a common memory management hub 240 for uniform translation into appropriate addresses in memory system 120, and memory management hub 240 is bidirectionally connected to data fabric 250 for generating such memory accesses and receiving read data returned from the memory system.

Data fabric 250 includes a crossbar switch for routing memory access requests and memory responses between any memory accessing agent and memory controllers 290. It also includes a system memory map, defined by BIOS, for determining destinations of memory accesses based on the system configuration, as well as buffers for each virtual connection.

Peripheral controllers 260 include a USB controller 262 and a SATA interface controller 264, each of which is bidirectionally connected to a system hub 266 and to the SMN bus. These two controllers are merely exemplary of peripheral controllers that may be used in APU 200.

Peripheral bus controllers 270 include a system controller or “Southbridge” (SB) 272 and a PCIe controller 274, each of which is bidirectionally connected to an input/output (I/O) hub 276 and to the SMN bus. I/O hub 276 is also bidirectionally connected to system hub 266 and to data fabric 250. Thus, for example a CPU core can program registers in USB controller 262, SATA interface controller 264, SB 272, or PCIe controller 274 through accesses that data fabric 250 routes through I/O hub 276.

SMU 280 is a local controller that controls the operation of the resources on APU 200 and synchronizes communication among them. SMU 280 manages power-up sequencing of the various processors on APU 200 and controls multiple off-chip devices via reset, enable and other signals. SMU 280 includes one or more clock sources not shown in FIG. 2, such as a phase locked loop (PLL), to provide clock signals for each of the components of APU 200. SMU 280 also manages power for the various processors and other functional blocks, and may receive measured power consumption values from CPU cores 212 and 214 and graphics core 220 to determine appropriate power states.

APU 200 also implements various system monitoring and power saving functions. In particular one system monitoring function is thermal monitoring. For example, if APU 200 becomes hot, then SMU 280 can reduce the frequency and voltage of CPU cores 212 and 214 and/or graphics core 220. If APU 200 becomes too hot, then it can be shut down entirely. Thermal events can also be received from external sensors by SMU 280 via the SMN bus, and SMU 280 can reduce the clock frequency and/or power supply voltage in response.

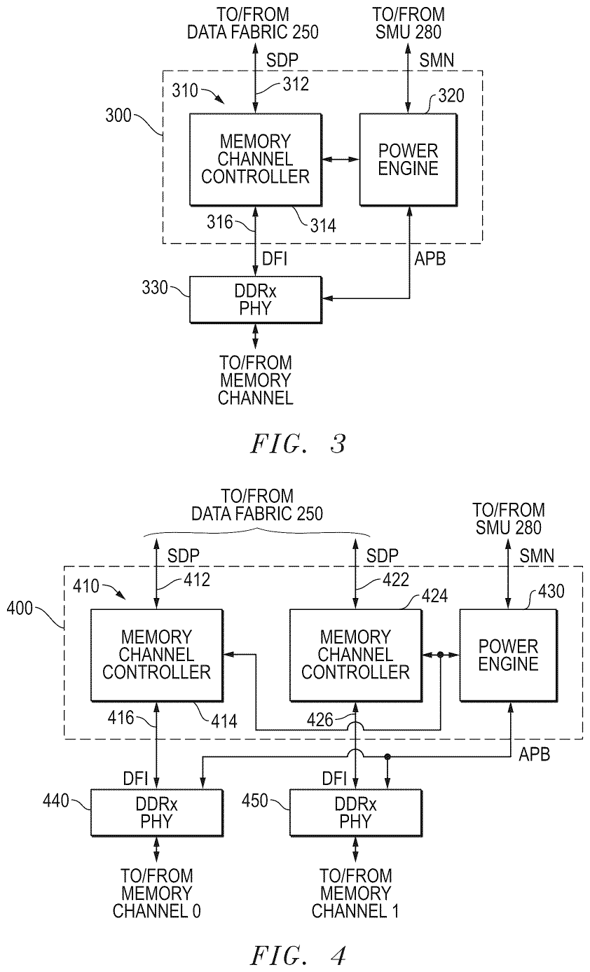

FIG. 3 illustrates in block diagram form a memory controller 300 and an associated physical interface (PHY) 330 suitable for use in APU 200 of FIG. 2 according to some embodiments. Memory controller 300 includes a memory channel 310 and a power engine 320. Memory channel 310 includes a host interface 312, a memory channel controller 314, and a physical interface 316. Host interface 312 bidirectionally connects memory channel controller 314 to data fabric 250 over a scalable data port (SDP). Physical interface 316 bidirectionally connects memory channel controller 314 to PHY 330 over a bus that conforms to the DDR-PHY Interface Specification (DFI). Power engine 320 is bidirectionally connected to SMU 280 over the SMN bus, to PHY 330 over the Advanced Peripheral Bus (APB), and is also bidirectionally connected to memory channel controller 314. PHY 330 has a bidirectional connection to a memory channel such as memory channel 130 or memory channel 140 of FIG. 1. Memory controller 300 is an instantiation of a memory controller for a single memory channel using a single memory channel controller 314, and has a power engine 320 to control operation of memory channel controller 314 in a manner that will be described further below.

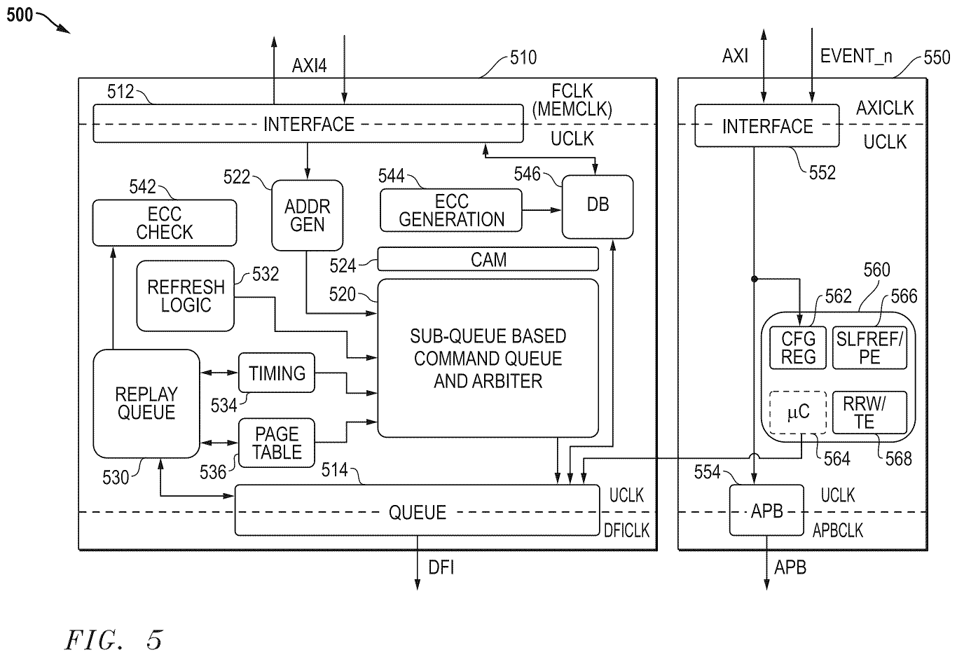

FIG. 4 illustrates in block diagram form another memory controller 400 and associated PHYs 440 and 450 suitable for use in APU 200 of FIG. 2 according to some embodiments. Memory controller 400 includes memory channels 410 and 420 and a power engine 430. Memory channel 410 includes a host interface 412, a memory channel controller 414, and a physical interface 416. Host interface 412 bidirectionally connects memory channel controller 414 to data fabric 250 over an SDP. Physical interface 416 bidirectionally connects memory channel controller 414 to PHY 440, and conforms to the DFI Specification. Memory channel 420 includes a host interface 422, a memory channel controller 424, and a physical interface 426. Host interface 422 bidirectionally connects memory channel controller 424 to data fabric 250 over another SDP. Physical interface 426 bidirectionally connects memory channel controller 424 to PHY 450, and conforms to the DFI Specification. Power engine 430 is bidirectionally connected to SMU 280 over the SMN bus, to PHYs 440 and 450 over the APB, and is also bidirectionally connected to memory channel controllers 414 and 424. PHY 440 has a bidirectional connection to a memory channel such as memory channel 130 of FIG. 1. PHY 450 has a bidirectional connection to a memory channel such as memory channel 140 of FIG. 1. Memory controller 400 is an instantiation of a memory controller having two memory channel controllers and uses a shared power engine 430 to control operation of both memory channel controller 414 and memory channel controller 424 in a manner that will be described further below.

FIG. 5 illustrates in block diagram form a memory controller 500 according to some embodiments. Memory controller 500 includes generally a memory channel controller 510 and a power controller 550. Memory channel controller 510 includes generally an interface 512, a queue 514, a sub-queue based command queue and arbiter 520, an address generator 522, a content addressable memory (CAM) 524, a replay queue 530, a refresh logic circuit 532, a timing block 534, a page table 536, an error correction code (ECC) check block 542, an ECC generation block 544, and a data buffer (DB) 546.

Interface 512 has a first bidirectional connection to data fabric 250 over an external bus, and has an output. In memory controller 500, this external bus is compatible with the advanced extensible interface version four specified by ARM Holdings, PLC of Cambridge, England, known as “AXI4”, but can be other types of interfaces in other embodiments. Interface 512 translates memory access requests from a first clock domain known as the FCLK (or MEMCLK) domain to a second clock domain internal to memory controller 500 known as the UCLK domain. Similarly, queue 514 provides memory accesses from the UCLK domain to the DFICLK domain associated with the DFI interface.

Address generator 522 decodes addresses of memory access requests received from data fabric 250 over the AXI4 bus. The memory access requests include access addresses in the physical address space represented in a normalized format. Address generator 522 converts the normalized addresses into a format that can be used to address the actual memory devices in memory system 120, as well as to efficiently schedule related accesses. This format includes a region identifier that associates the memory access request with a particular rank, a row address, a column address, a bank address, and a bank group. On startup, the system BIOS queries the memory devices in memory system 120 to determine their size and configuration, and programs a set of configuration registers associated with address generator 522. Address generator 522 uses the configuration stored in the configuration registers to translate the normalized addresses into the appropriate format.

Sub-queue based command queue and arbiter 520 includes both a command queue and an arbiter. The command queue is a queue of memory access requests received from the memory accessing agents in data processing system 100, such as CPU cores 212 and 214 and graphics core 220. The command queue stores the address fields decoded by address generator 522 as well other address information that allows the arbiter to select memory accesses efficiently, including access type and quality of service (QoS) identifiers. CAM 524 includes information to enforce ordering rules, such as write after write (WAW) and read after write (RAW) ordering rules. The arbiter is bidirectionally connected to the command queue and is the heart of memory channel controller 510. It improves efficiency by intelligent scheduling of accesses to improve the usage of the memory bus. The arbiter uses timing block 534 to enforce proper timing relationships by determining whether certain accesses in the command queue are eligible for issuance based on DRAM timing parameters. For example, each DRAM has a minimum specified time between activate commands, known as “tRC”. Timing block 534 maintains a set of counters that determine eligibility based on this and other timing parameters specified in the JEDEC specification, and is bidirectionally connected to replay queue 530. Page table 536 maintains state information about active pages in each bank and rank of the memory channel for the arbiter, and is bidirectionally connected to replay queue 530.

Replay queue 530 is a temporary queue for storing memory accesses picked by the arbiter that are awaiting responses, such as address and command parity responses, write cyclic redundancy check (CRC) responses for DDR4 DRAM or write and read CRC responses for gDDR5 DRAM. Replay queue 530 accesses ECC check block 542 to determine whether the returned ECC is correct or indicates an error. Replay queue 530 allows the accesses to be replayed in the case of a parity or CRC error of one of these cycles.

Refresh logic circuit 532 includes state machines for various powerdown, refresh, and termination resistance (ZQ) calibration cycles that are generated separately from normal read and write memory access requests received from memory accessing agents. For example, if a memory rank is in precharge powerdown, it must be periodically awakened to run refresh cycles. Refresh logic circuit 532 generates refresh commands periodically to prevent data errors caused by leaking of charge off storage capacitors of memory cells in DRAM chips. In addition, refresh logic circuit 532 periodically calibrates ZQ to prevent mismatch in on-die termination resistance due to thermal changes in the system.

In response to write memory access requests received from interface 512, ECC generation block 544 computes an ECC according to the write data. DB 546 stores the write data and ECC for received memory access requests. It outputs the combined write data/ECC to queue 514 when the arbiter picks the corresponding write access for dispatch to the memory channel.

Power controller 550 generally includes an interface 552 to an advanced extensible interface, version one (AXI), an APB interface 554, and a power engine 560. Interface 552 has a first bidirectional connection to the SMN, which includes an input for receiving an event signal labeled “EVENT_n” shown separately in FIG. 5, and an output. APB interface 554 has an input connected to the output of interface 552, and an output for connection to a PHY over an APB. Power engine 560 has an input connected to the output of interface 552, and an output connected to an input of queue 514. Power engine 560 includes a set of configuration registers 562, a microcontroller (uC) 564, a self refresh controller (SLFREF/PE) 566, and a reliable read/write timing engine (RRW/TE) 568. Configuration registers 562 are programmed over the AXI bus, and store configuration information to control the operation of various blocks in memory controller 500. Accordingly, configuration registers 562 have outputs connected to these blocks that are not shown in detail in FIG. 5. Self refresh controller 566 is an engine that allows the manual generation of refreshes in addition to the automatic generation of refreshes by refresh logic circuit 532. Reliable read/write timing engine 568 provides a continuous memory access stream to memory or I/O devices for such purposes as DDR interface maximum read latency (MRL) training and loopback testing.

Memory channel controller 510 includes circuitry that allows it to pick memory accesses for dispatch to the associated memory channel. In order to make the desired arbitration decisions, address generator 522 decodes the address information into predecoded information including rank, row address, column address, bank address, and bank group in the memory system, and the command queue stores the predecoded information. Configuration registers 562 store configuration information to determine how address generator 522 decodes the received address information. The arbiter uses the decoded address information, timing eligibility information indicated by timing block 534, and active page information indicated by page table 536 to efficiently schedule memory accesses while observing other criteria such as QoS requirements. For example, the arbiter implements a preference for accesses to open pages to avoid the overhead of precharge and activation commands required to change memory pages, and hides overhead accesses to one bank by interleaving them with read and write accesses to another bank. In particular during normal operation, the arbiter normally keeps pages open in different banks until they are required to be precharged prior to selecting a different page.

Memory Controllers with Sub-Queue Architecture

FIG. 6 illustrates in block diagram form a portion of a memory controller 600 with a sub-queue architecture. Memory controller 600 includes a command queue entry logic circuit 610, a command sub-queue 620, a command sub-queue 630, and a selector 640.

Command queue entry logic circuit 610 has an input connected to the output of address generator 522, a first output, and a second output. Command queue entry logic circuit 610 routes memory access requests received from address generator 522 to one of the first output for use by a first command sub-queue 620, or the second output for use by command sub-queue 630. Command queue entry logic circuit 610 can separate the accesses in a variety of ways to allow power savings. The following discussion will refer to a particular example of sorting by access type, either read memory access requests or write memory access requests, but it should be understood that other criteria can form the basis for separation into either first command sub-queue 620 or second command sub-queue 630.

Command sub-queue 620 has an input connected to the first output of command queue entry logic circuit 610, and an output, and includes a queue 621 and an arbiter 622. As with the command queue in memory controller 500, queue 621 stores memory access requests and corresponding attributes that can be used to efficiently pick eligible accesses, and arbiter 622 picks memory access requests according to a set of arbitration rules that ensure both efficiency and fairness. Command sub-queue 630 has an input connected to the second output of command queue entry logic circuit 610, and an output, and includes a queue 631 and an arbiter 632. As in command sub-queue 620, queue 631 stores memory access requests and corresponding attributes that can be used to efficiently pick eligible accesses, and arbiter 632 picks memory access requests according to a set of arbitration rules that ensure both efficiency and fairness.

Selector 640 has a first input connected to the output of command sub-queue 620, a second input connected to the output of command sub-queue 630, and an output connected to queue 514. Selector 640 picks memory access requests from the outputs of command sub-queue 620 and command sub-queue 630. Selector 640 includes a multiplexer 641 and an arbiter 642. Multiplexer 641 has a first input connected to the output of command sub-queue 620, a second input connected to the output of command sub-queue 630, a control input, and an output connected to queue 514. Arbiter 642 has an output connected to the control input of multiplexer 641. Arbiter 642 uses a set of arbitration rules that increase efficiency while maintaining fairness but may be simpler than arbiters 622 and 632.

In one particular example, command sub-queue 620 and command sub-queue 630 can receive approximately equal numbers of memory access requests from command queue entry logic circuit 610, in which case arbiter 642 could select memory access requests from command sub-queue 620 and command sub-queue 630 in a round-robin fashion, or use any other criteria that allow eligible memory access requests to make consistent progress to completion. In this example, each of queues 621 and 631 can have a smaller number of entries than a memory controller with a single command queue, and arbiters 622 and 632 can have fewer levels of priority logic, allowing faster arbitration resolution, allowing the arbiter to operate up to a higher clock frequency.

In another example, one command sub-queue (e.g., command sub-queue 620) can receive read memory access requests, the other command sub-queue (e.g., command sub-queue 630) can receive write memory access requests. In this case, arbiter 642 selects memory access requests from one of the command sub-queues for as long as possible in order to preserve efficiency, but switches to selecting accesses of the other type after a certain number of cycles to preserve fairness.

The inventor of the present application realized that this second example provides additional benefits not previously recognized. For example, because one of the command queues (e.g., write) will be waiting during a streak of reads, there is an opportunity to save power while using the command sub-queue architecture. Thus, it is possible to place one of the command queues (the one assigned to write memory access request) into a low power mode during a streak of the other type of memory access requests (e.g., read), and then bring it out of the low-power mode when the streak ends, will end at a definite time in the future, or is predicted to end at a definite time in the future. A concrete example will now be discussed.

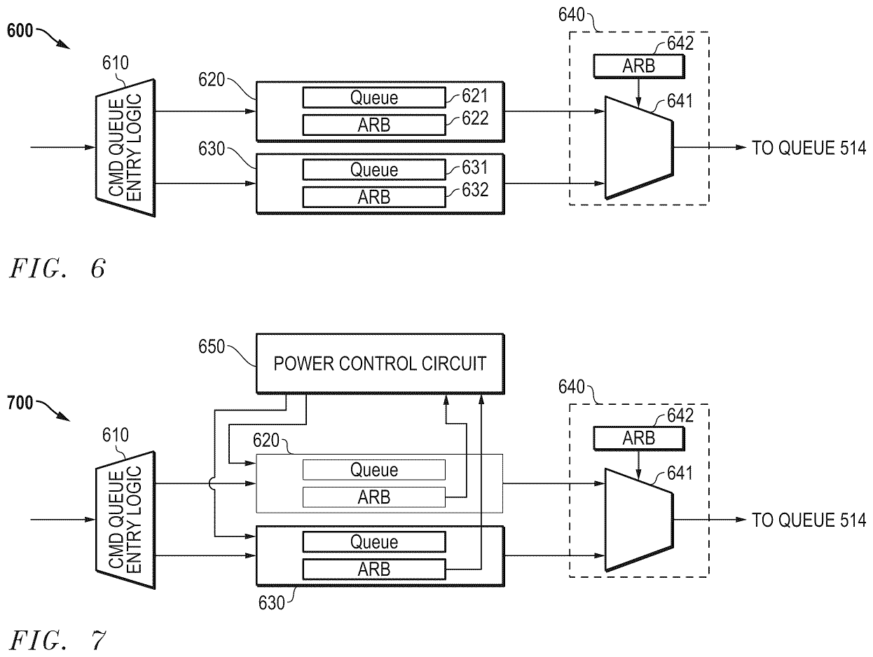

FIG. 7 illustrates in block diagram form a portion of a memory controller 700 with a sub-queue architecture according to some implementations. Memory controller 700 includes the same elements as memory controller 600, but additionally includes a power control circuit 650. Power control circuit 650 has a first input connected to arbiter 622 in command sub-queue 620, a second input connected to arbiter 632 in command sub-queue 630, a first output connected to command sub-queue 620, and a second output connected to command sub-queue 630. Power control circuit 650 is operable to place one of the first and second command sub-queues into a low power mode while keeping the other one active. In the example given above, if command sub-queue 620 is dedicated to write memory access requests and command sub-queue 630 is dedicated to read memory access requests, then power control circuit 650 will place command sub-queue 620 in a low-power mode during a streak of read accesses. Conversely, when the current streak changes to write accesses, power control circuit 650 will place command sub-queue 630 in a low power while keeping command sub-queue 620 active during a streak of write accesses.

It should be noted that there are various low power modes that could be used to save power. These low-power modes differ in their “depth”, that is, how long it takes to return from the low-power mode to the normal mode. One example of a shallow low-power mode is clock gating. Since complementary metal-oxide-semiconductor (CMOS) logic circuits are static circuits, they generally retain their logic states when the clock signal is removed as long as they continue to be powered. CMOS circuits can return to normal power mode from clock gated mode in about one clock cycle. One example of a deep low power mode is powerdown mode. Powerdown mode is a deeper low power state because not only does it save the power due to clocking, but also due to the combined small leakage from a large number of transistors that, in the aggregate, is significant. However, it takes much longer periods of time to return to normal operation mode. An example of an intermediate low-power mode is retention mode, in which clock signals are removed, and dynamic circuits like registers and memory cells receive a reduced power supply voltage that is sufficient to retain their states but that also reduces leakage current.

Since the command queue and arbitration logic form a large percentage of the circuit area of a memory controller, which itself takes up a large portion of the multi-core data processor, the sub-queue architecture provides significant power savings with only a small increase in overall circuit area.

Memory Controllers with Nested Sub-Queue Architecture

The sub-queue architecture can be nested into additional levels of arbitration, increasing the flexibility of this architecture and of the granularity of the power saving methodology. Three particular examples will now be described.

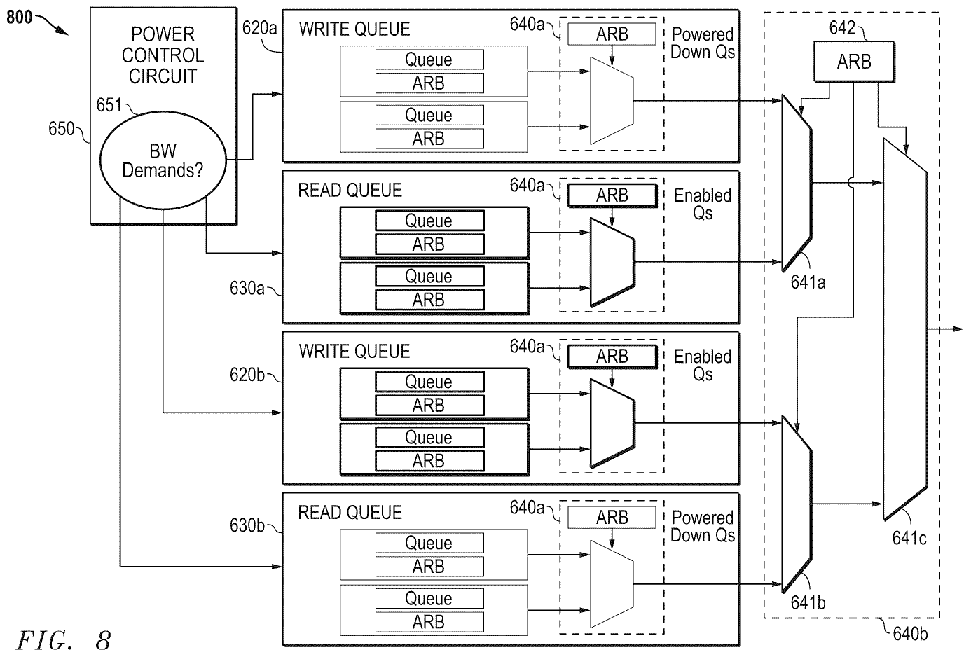

FIG. 8 illustrates in block diagram form a portion of a memory controller 800 with a nested sub-queue architecture according to some implementations. Memory controller 800 includes a command queue entry logic circuit (not shown in FIG. 8), command sub-queue 620, command sub-queue 630, and selector 640, and power control circuit 650, all similar to corresponding circuits previously described. In the nested sub-queue architecture, command sub-queue 620 is formed by command sub-queues 620a and 620b, command sub-queue 630 is formed by command sub-queues 630a and 630b, and selector 640 is formed by nested selectors including selectors 640a and 640b associated with command sub-queues 620 and 620b, respectively, and a final selector 640c. Power control circuit 650 includes a bandwidth demand evaluation circuit 651 described above.

Nested command sub-queue 620a is a write command sub-queue and includes two nested write command sub-queues each having a respective command queue and a respective arbiter. Similarly, nested command sub-queue 620b is also a write command sub-queue and includes two nested write command sub-queues each having a respective command queue and a respective arbiter.

Nested command sub-queue 630a is a read command sub-queue and includes two nested read command sub-queues each having a respective command queue and a respective arbiter. Similarly, nested command sub-queue 630b is also a read command sub-queue and includes two nested read command sub-queues each having a respective command queue and a respective arbiter.

Each of selectors 640a is associated with one of the two nested command sub-queues, and each includes a multiplexer and an arbiter that operate similarly to multiplexer 641 and arbiter 642 described above. Selector 640b performs a final selection, in which a first selector 641a selects between the outputs of nested write command sub-queue 620a and nested read command sub-queue 630a, a second selector 641b selects between the outputs of nested write command sub-queue 620b and nested read command sub-queue 630b, and a third level selector 641c selects between the outputs of second level selectors 641a and 641b. All selectors are controlled by arbiter 642.

In order to save power, power control circuit 650 puts write command sub-queue 620a and read command sub-queue 630b into a low-power state, while keeping read command sub-queue 630a and write command sub-queue 630b in the active state. Power control circuit 650 also monitors the activity of the nested command sub-queues to determine which nested command sub-queues can be deactivated and which nested command sub-queues are utilized and can be kept active. In this example, power control circuit 650 has determined that there is a moderate workload with a balance between read and write memory access requests that requires only a portion of the command sub-queues to remain active. In this example, power control circuit 650 can also cooperate with command queue entry logic circuit 610 to dispatch the read and write memory access requests only to the active nested command sub-queues. Arbiter 642 selects between read memory access requests from read command queue 630 and write memory access requests from nested write command sub-queue 620b generally by allowing streaks of reads and writes to continue until it determines that a cross-mode switch should be performed.

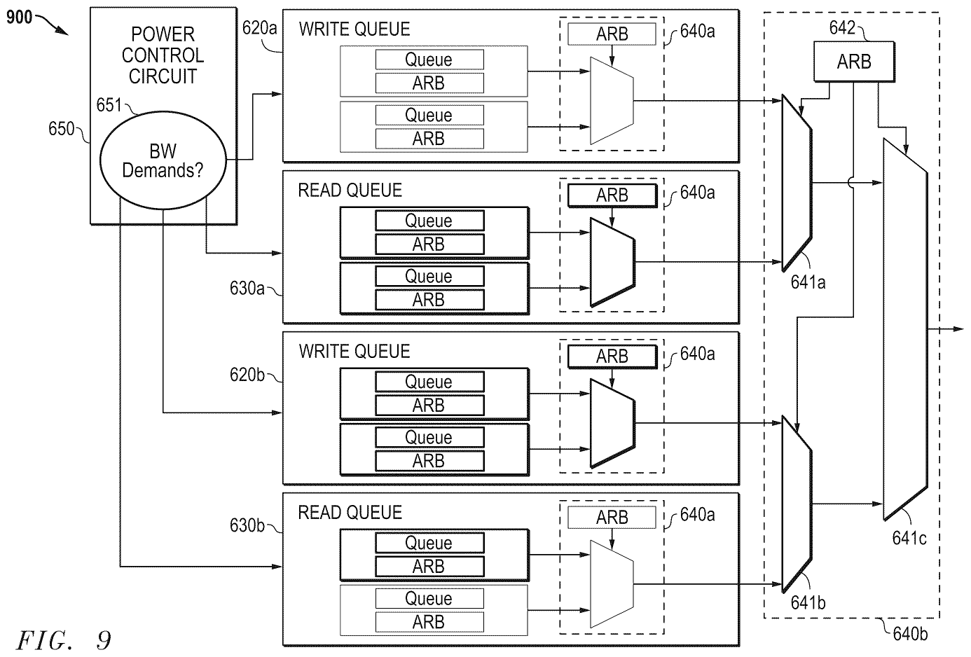

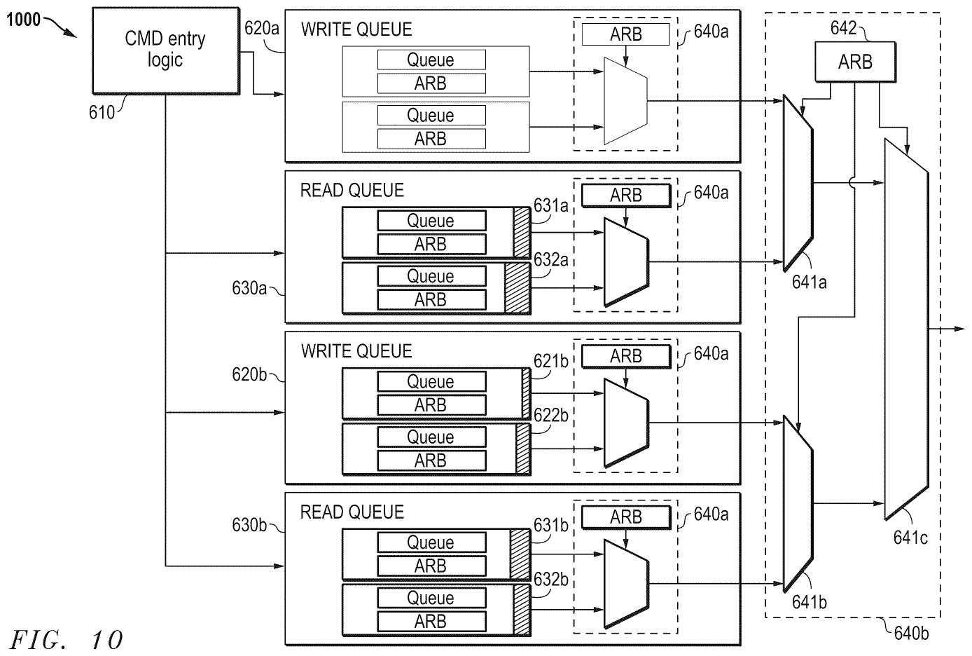

FIG. 9 illustrates in block diagram form a portion of a memory controller 900 with a nested sub-queue architecture according to some implementations. Memory controller 900 is constructed the same as memory controller 800, but at this point in operation, power control circuit 650 has enabled both command queues in nested command sub-queues 630a and 620b, and one read command sub-queue in nested read command sub-queue 630b. Memory controller 900 shows the granularity with which the command sub-queue architecture, and in particular the nested command sub-queue architecture, can provide power and performance granularity as bandwidth demands change.

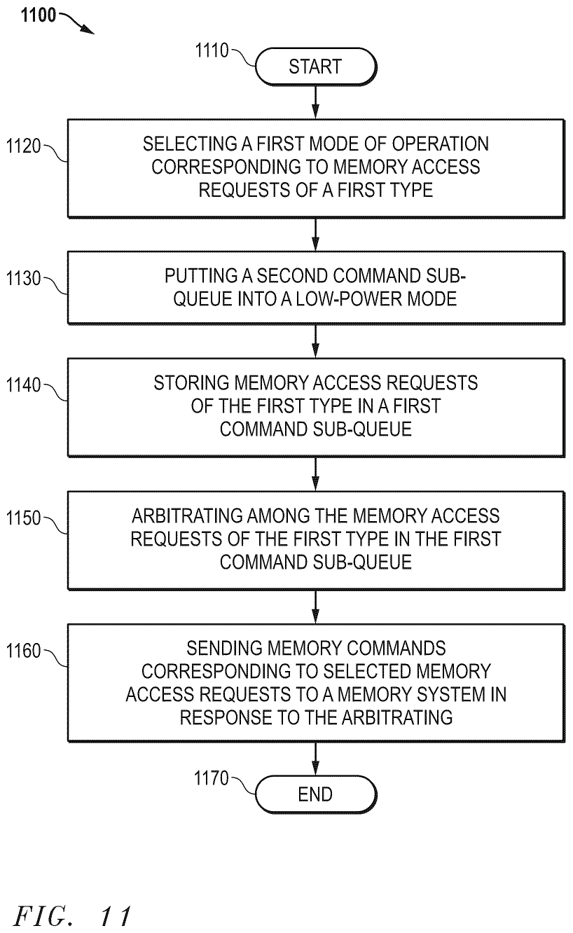

FIG. 10 illustrates in block diagram form a portion of yet another memory controller 1000 with a nested sub-queue architecture according to some implementations. Memory controller 1000 implements the same power control features as shown in FIG. 9. However, it shows another technique for further power savings that can be used independently or in conjunction with the power savings techniques of the sub-queue and nested sub-queue architectures described above. Memory controller 1000 shows an example in which nested command sub-queues 620b, 630a, and 630b are active, and nested command sub-queue 620a is inactive. In this example, nested command sub-queue 630a has a valid entry region 631a in the first command sub-queue and a valid entry region 632a in the second command sub-queue, with the remainder of entries invalid. Nested command sub-queue 620b has a valid entry region 621b in the first command sub-queue and a valid entry region 622b in the second command sub-queue, with the remainder of entries invalid. Nested command sub-queue 630b has a valid entry region 631b in the first command sub-queue and a valid entry region 632b in the second command sub-queue, with the remainder of entries invalid.

A command queue is a large data array with many entries, each having numerous bits. When a memory access request is selected to be sent to memory, the valid entries are shifted through the array to fill the vacated slots caused by a selected memory access request being removed from the array during the previous arbitration. The shifting operation consumes a significant amount of power, which increases as the number of valid entries increases. In memory controller 1000, command queue entry logic circuit 610 is operable to spread requests substantially evenly between two or more command sub-queues of the same type, such as valid entry regions 631a and 631b in command sub-queue 620b, between valid entry regions 621b and 622b in command sub-queue 620b, and between valid entry regions 631b and 632b in command sub-queue 630b. In this way, memory controller 1000 consumes less power by shifting fewer entries. Moreover, this technique can be used in conjunction with the other power saving mechanisms discussed herein.

It should be apparent from these examples that the nesting of command sub-queues can be extended to an arbitrary number of nesting levels. A user can extend the amount of nesting to meet power specifications with only a relatively small amount of added circuit area.

FIG. 11 illustrates a flow chart 1100 of a method of saving power in a multi-queue architecture according to some implementations. The method starts in an action box 1110. In an action box 1120, a first mode of operation corresponding to memory access requests of a first type is selected. In an action box 1130, a second command sub-queue is put into a low-power mode. In an action box 1140, memory access requests of the first type are stored in a first command sub-queue. In an action box 1150, thew method includes arbitrating among the memory access requests of the first type in the first command sub-queue. In an action box 1160, memory commands corresponding to selected memory access requests are sent to a memory system in response to the arbitrating. In an action box 1170, the method ends.

Thus, a data processor, data processing system, and method have been described that can be used to save power in a large memory controller. The command queue is broken into a number of command sub-queues. The present application discloses several power saving techniques that leverage the command sub-queue architecture. One technique is to put a command sub-queue and its arbiter, dedicated to one of read or write requests into a low-power state during a streak of opposite-type commands. Since current and expected future memories, including industry standard DDR DRAMs, require a large amount of time to switch from reads to writes and from writes to reads, command sub-queues can be placed into a low power state during a streak of opposite-mode commands. The second technique scales the number of active command sub-queues and associated arbiter circuits, such as read commands and write commands, based on the current workload. For example, if the current workload generates more reads than writes, then fewer write command sub-queues need to be active. The third technique is to equalize the number of commands among active command sub-queues of a particular type in each available command sub-queue of that type. Leveling the number of commands reduces average power consumption, which depends on the number of shift operations performed after each command generation cycle.

While particular implementations have been described, various modifications of these implementations will be apparent to those skilled in the art. For example, the various techniques described herein may be implemented separately or may be combined. The present disclosure may be practiced with different low power modes, such as clock gating and powerdown, as well as in-between low-power modes such as memory retention. The available number of command sub-queues of particular types, such as read and write, that are in a normal power mode during operation may vary. While the exemplary implementation used double data rate memory, other memory types may be used in other implementations.

Accordingly, it is intended by the appended claims to cover all modifications of the disclosed implementations that fall within the scope of the disclosed implementations.

1. A memory controller for a memory channel, comprising:
first and second command sub-queues having corresponding first and second arbiters for selecting requests from respective ones of first and second sub-queues for issuance as commands to the memory channel; and
a power control circuit operable to place one of the first command sub-queue and the second command sub-queue into a low power mode while keeping another one of the first command sub-queue and the second command sub-queue active.

2. The memory controller of claim 1, wherein:
the first command sub-queue is a read command sub-queue;
the second command sub-queue is a write command sub-queue; and
the power control circuit puts one of the read command sub-queue and the write command sub-queue into the low power mode based on a command type of a current streak.

3. The memory controller of claim 1, further comprising:
a command queue entry logic circuit operable to dispatch memory access requests selectively to the first command sub-queue and the second command sub-queue based on command type.

4. The memory controller of claim 1, wherein:
the low power mode is a selected one of a first low power mode having a first depth, and a second low power mode having a second depth deeper than the first depth.

5. The memory controller of claim 4, wherein:
the first low power mode is a clock-gated mode and the second low power mode is a powered down mode.

6. The memory controller of claim 1, wherein:
each of the first arbiter and the second arbiter selects between page hit requests, page miss requests, and page conflict requests in its respective queue.

7. The memory controller of claim 1, wherein:
the memory controller further comprises a third command sub-queue and a fourth command sub-queue;
each the first command sub-queue and the third command sub-queue processes requests of a first type; and
each of the second command sub-queue and the fourth command sub-queue processes requests of a second type different from the first type.

8. The memory controller of claim 7, further comprising:
a command queue entry logic circuit operable to spread requests substantially evenly between the first command sub-queue and the second command sub-queue.

9. A data processing system, comprising:
a data processor core for generating memory access requests;
a memory controller coupled to the data processor core to generate memory commands responsive to the memory access requests; and
a memory coupled to the memory controller over a memory channel and responsive to the memory access requests to transfer data to or from the memory controller, wherein the memory controller comprises:
first and second command sub-queues having corresponding first and second arbiters for selecting requests from respective ones of first and second queues for issuance as commands to the memory channel; and
a power control circuit operable to place one of the first command sub-queue and the second command sub-queue into a low power mode while keeping another one of the first command sub-queue and the second command sub-queue active.

10. The data processing system of claim 9, wherein:
the first command sub-queue is a read command sub-queue;
the second command sub-queue is a write command sub-queue; and
the power control circuit puts one of the read command sub-queue and the write command sub-queue into the low power mode based on a current command type.

11. The data processing system of claim 9, further comprising:
a command queue entry logic circuit operable to dispatch memory access requests selectively to the first command sub-queue and the second command sub-queue based on command type.

12. The data processing system of claim 9, wherein:
the low power mode is a selected one of a first low power mode having a first depth, and a second low power mode having a second depth deeper than the first depth.

13. The data processing system of claim 12, wherein:
the first low power mode is a clock-gated mode and the second low power mode is a powered down mode.

14. The data processing system of claim 9, wherein:
each of the first arbiter and the second arbiter selects between page hit requests, page miss requests, and page conflict requests in its respective queue.

15. The data processing system of claim 9, wherein:
the memory controller further comprises a third command sub-queue and a fourth command sub-queue;
each the first command sub-queue and the third command sub-queue processes requests of a first type; and
each of the second command sub-queue and the fourth command sub-queue processes requests of a second type different from the first type.

16. The data processing system of claim 15, further comprising:
a command queue entry logic circuit operable to spread requests substantially evenly between the first command sub-queue and the second command sub-queue.

17. A method, comprising:
selecting a first mode of operation corresponding to memory access requests of a first type;
putting a second command sub-queue into a low-power mode;
storing memory access requests of the first type in a first command sub-queue;
arbitrating among the memory access requests of the first type in the first command sub-queue; and
sending memory commands corresponding to selected memory access requests to a memory system in response to the arbitrating.

18. The method of claim 17, further comprising:
determining to switch from the first mode of operation to a second mode of operation corresponding to memory access requests of a second type;
putting the second command sub-queue into a normal power mode;
dispatching a plurality of memory access requests to the second command sub-queue;
switching from the first mode to the second mode; and
arbitrating among the memory access requests of the second type in the second command sub-queue, and sending memory commands corresponding to selected memory access requests to the memory system.

19. The method of claim 18, wherein:
determining to switch from the first mode to the second mode comprises determining to switch from a read mode to a write mode.

20. The method of claim 18, wherein:
putting the second command sub-queue into the low-power mode comprises putting the second command sub-queue into one of a clock gated more and a powered down mode.
